(19) United States
(12) Patent Application Publication
(10) Pub. No.: US 2025/0149191 A1
(43) Pub. Date: May 8, 2025

(54) Carbon Fusion Reactor and Uses Thereof

(71) Applicant: West Nanorobotics LLC, Pendleton, IN (US)

(72) Inventor: Tory C. Weston, Pendleton, IN (US)

(73) Assignee: West Nanorobotics LLC, Pendleton, IN (US)

(21) Appl. No.: 18/501,986

(22) Filed: Nov. 4, 2023

(51) Int. Cl. G21B 1/05

(52) U.S. Cl. CPC G21B 1/05

(57) ABSTRACT

This is a Nuclear Fusion Reactor using the Carbon Nitrogen Oxygen Cycle (CNO) to generate energy in the form of heat and anti-matter particles such as positrons. The “Carbon Fusion Reactor” is heated to a self-sustaining reaction by the introduction of sodium 22 which decays into positrons and neon 22 via beta positive decay method heating the plasma to above 16 million kelvin upon reacting with electrons. The device is shaped as a tokomak the hydrogen plasma being contained in a magnetic field that is greater than 10,000 Teslas in magnitude allowing the Carbon Fusion events to happen within the torus shaped reaction chamber at 16 million kelvins or higher temperature.

### BRIEF SUMMARY

This is a “Carbon Fusion Reactor” that uses the Carbon Nitrogen Oxygen Cycle (CNO) to generate energy in the form of anti-matter particles such as positrons and energy in the form of heat. The device is a Torus shaped tokomak fusion reactor with superconductors such as cuprates or iron based superconductors of 30 Teslas per meter or above used to contain the hydrogen plasma used in the reactor along with the carbon 12 that is used as a catalyst for the Carbon Nitrogen Oxygen Cycle (CNO). There is a central solenoid in the middle of the torus shaped reactor that moves the hydrogen plasma and carbon 12 around the device in a circle allowing for the magnetic field of greater than 10,000 Teslas in magnitude to contain it which the superconductors are coiled around the torus shape of the reaction chamber in the form of wire making the plasma not touch the inner surface of the chamber via magnetic repulsion. To heat the plasma sodium 22 isotopes are introduced into the chamber of hydrogen plasma and carbon 12 to heat the mixture to 16 million kelvins or higher allowing for the self-sustaining Carbon Nitrogen Oxygen Cycle (CNO) to take place consuming non-isotope hydrogen to generate energy in the form of positrons and heat. The Sodium 22 isotopes decay via beta positive decay into positrons and neon 22 which the positrons then annihilate with electrons present around the carbon 12 and hydrogen plasma generating gamma radiation which is absorbed by the hydrogen plasma and carbon 12 heating it. Once, the reaction is heated to 16 million kelvins or higher the Carbon Nitrogen Oxygen Cycle (CNO) is happening and the energy from the reaction keeps the plasma above that temperature making it self-sustaining and generating excess energy above that which can be extracted by removing plasma from the device to heat water which will move a turbine to generate electricity just as a standard nuclear fission reactor.

### BRIEF DESCRIPTION OF THE FIGURES

FIG. 1, Tokomak Carbon Fusion Reactor Design

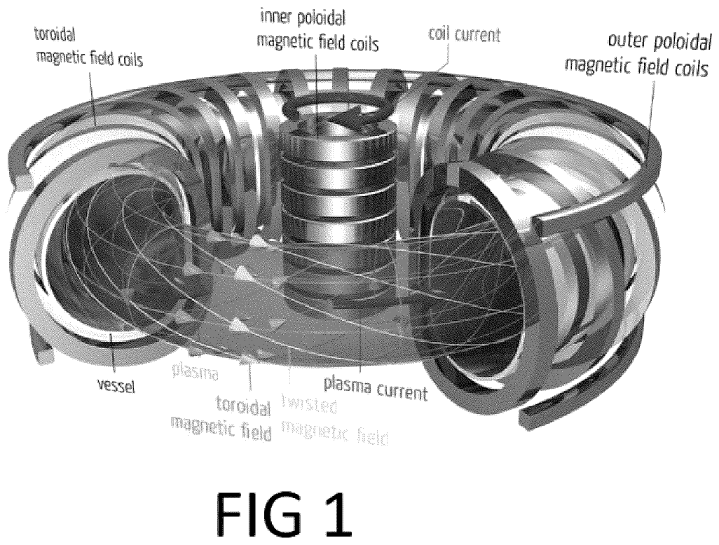

FIG. 2, Carbon Nitrogen Oxygen Cycle (CNO) Diagram

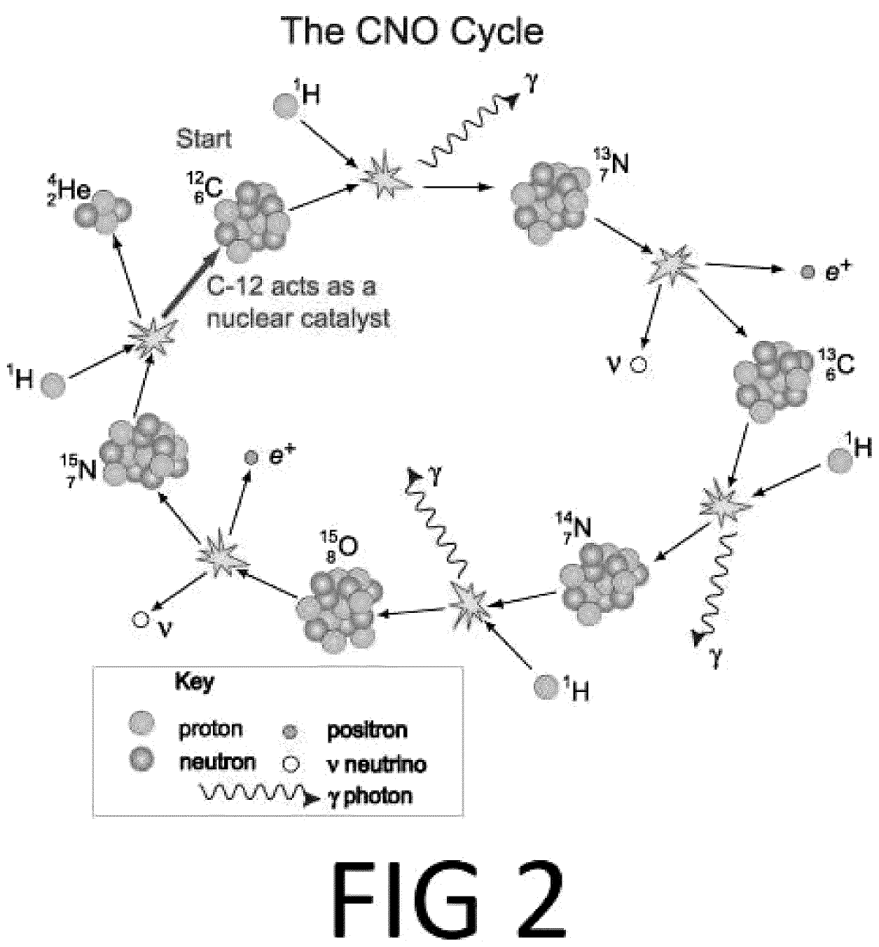

FIG. 3, Sodium 22 Decay Via Beta Positive Decay Diagram

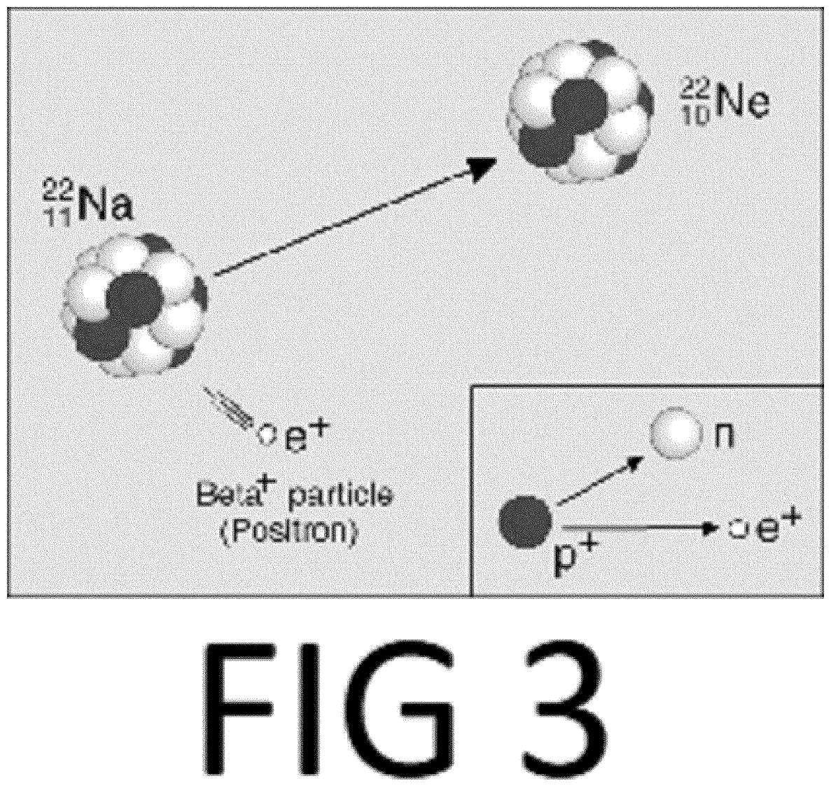

FIG. 4, Fusion Reactor Plasma Turbulence Diagram In The Entire Chamber

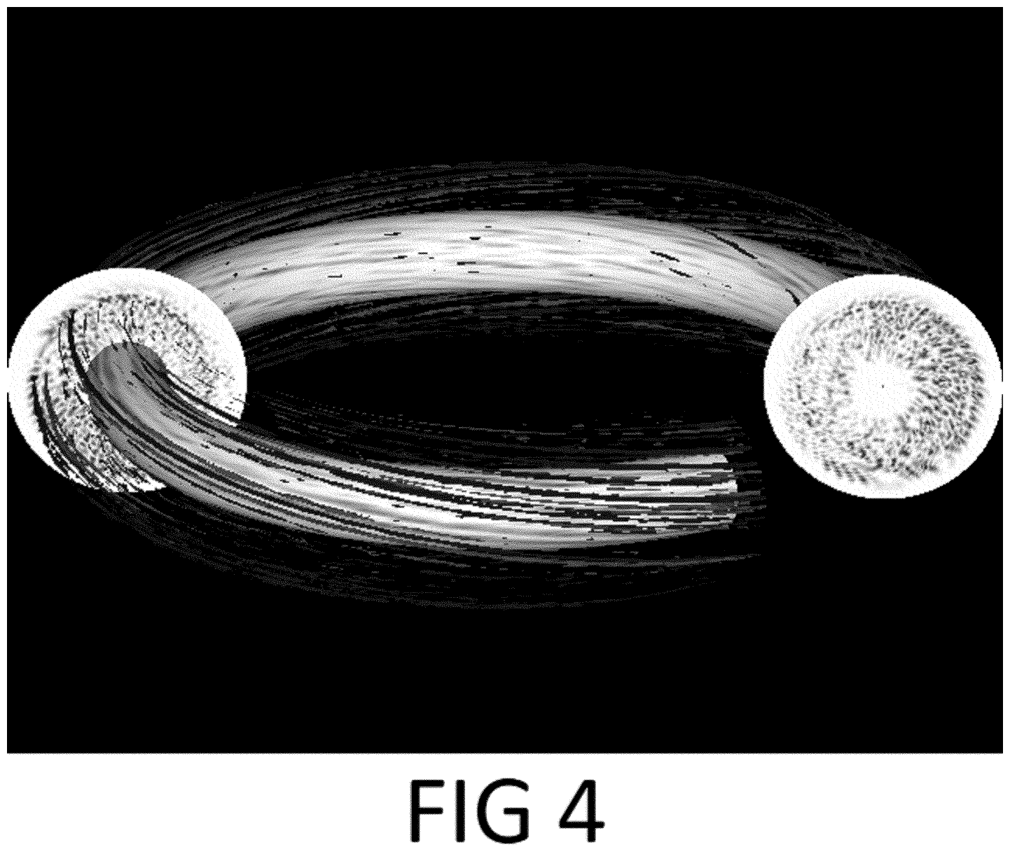

FIG. 5, Cross Section of Fusion Reactor Plasma Turbulence Diagram

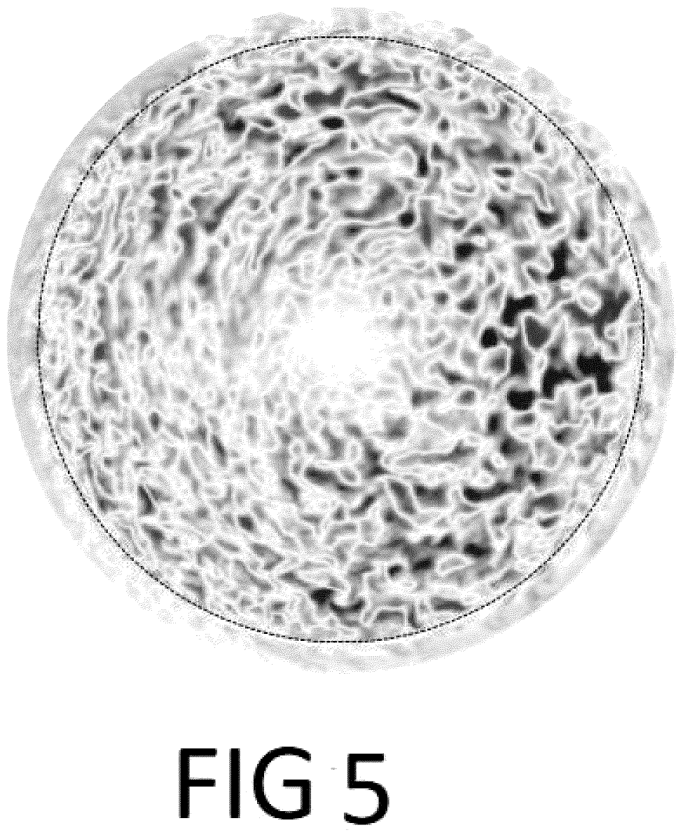

### DETAILED DESCRIPTION

There are several parts to this “Carbon Fusion Reactor” which will be explained being the Carbon Nitrogen Oxygen Cycle (CNO), Sodium 22 Heating, Critical Temperature, Critical Magnetism, The Torus Chamber, and Plasma Turbulence.

First, there are several types of Carbon Nitrogen Oxygen Cycle but the primary one is CNO-I used in this reactor which liberates 26.73 Mev of energy which includes the positron's annihilation with electrons and heat. The Cycle transforms Carbon 12 to Nitrogen 13 to Carbon 13 to Nitrogen 14 to Oxygen 15 to Nitrogen 15 to Carbon 12 making a closed loop the Carbon 12 is just used as a catalyst for the Fusion reaction. The entire time this “loop reaction” is running it liberates energy by consuming non-isotope hydrogen transforming it into various products such as helium 4, positrons, and gamma radiation. Each cycle consumes 4 non-isotope hydrogen atoms and produces 1 helium 4 atom along with 2 positrons and 3 gamma radiation photons. The other Carbon Nitrogen Oxygen cycles (CNO) could be used be either require unobtainable temperatures or liberate less energy from the cycle thus are not used however could be used. There are a total of seven different Carbon Nitrogen Oxygen Cycle that could be used however will not be discussed because of technical problems with making conditions necessary for the reaction or lack of liberated energy however there is CNO-II, CNO-III, CNO-IV, HCNO-I, HCNO-II, HCNO-III and of course the one being used in the “Carbon Fusion Reactor” CNO-I. The energy obtained of the entire 1 meter cubed plasma of 4:1 ratio non-isotopic Hydrogen to carbon 12 is 42.3 Terajoules which can continuously be replaced with more of the plasma at a ratio of 4:1 making more energy over a period of time producing at maximum 42.3 Terawatts of energy if the entire reaction chamber is spent in 1 second. The more stable route may be the make the reaction happen at 5 gigawatts over a period of 8,460 seconds producing 42.3 terawatts over a longer period of time.

Second, There is the heating of the hydrogen and Carbon 12 mixture which uses sodium 22. Sodium 22 can be produced by bombarding protons into magnesium or aluminum targets which has been known about since the 60s. The sodium 22 when it decays releases a positron transforming into neon 22 which the positron will annihilate with a electron in the plasma making two gamma radiation photons heating the non-isotopic hydrogen and carbon 12 mixture. Each Annihilation of a positron produces two 511 key gamma radiation photons thus heating the mixture into a plasma state of 16 million kelvins or higher with moderate amounts of sodium 22 isotope allowing for the CNO-I cycle to become self-sustaining after heating with gamma radiation produced from positron-electron annihilation. The Sodium 22 can be mixed directly into the non-isotope Hydrogen and Carbon 12 for heating it will have no effect on the CNO-I reaction other than heating the mixture.

Third, the critical temperature of the CNO-I cycle is 16 million kelvin or higher if the temperature falls below 16 million kelvin then the reaction will stop being that the products and energy will stop being produced. For this reason I consider that a proper temperature for this reactor would be above 100 million kelvins or higher to have a safe margin for temperature fluctuation in the actual reaction chamber. The 26.73 Mev reaction of CNO-I will keep the reaction stable as the plasma does not touch the inner chamber wall but if it does begin to fall below the temperature of 100 million kelvin then more Sodium 22 isotopes can be added to the mixture to keep the temperature above the reaction temperature. This should allow for continuous energy production from the reaction for longer than deuterium/tritium fusion reactors. As plasma is removed to heat water to power a turbine the temperatures will need to be carefully monitored otherwise you risk dropping the temperature below the critical temperature for the reaction of 16 million kelvins which is why a temperature of 100 million kelvin is sustained to keep a safety net before the reaction actually stops allowing for the removal of plasma without interruption of the reaction.

Fourth, Critical Magnetism which will need to remain above 10,000 Teslas to keep the plasma confined which means if a 1 meter cubed chamber in the middle of the torus is used the walls would need to be coiled with 6.93 meters thickness of the outside wall of superconductor wire that is 30 Teslas per meter. This will confine the plasma into a circular “beam” of plasma containing hydrogen and carbon 12 under those pressures plasma turbulence becomes negligible. The Central solenoid needs to be strong enough to move the carbon 12 and hydrogen plasma at 337 meters per second or higher to keep confinement of the plasma the higher the velocity of the plasma is the better. For safety the plasma should be kept at above 10,000 meters per second in the chamber requiring a solenoid equal to 30 Teslas or higher producing a force of 100 GigaNewtons on the plasma moving at 10,000 meters per second. The 10,000 Tesla superconductor shell of the device will produce a force of 30 PetaNewtons of compression on the plasma of hydrogen and carbon 12 at these specifications with a 10,000 Tesla magnetic field strength.

Fifth, the Torus reaction chamber will have a inner radius of 0.15 meters allowing for a 1 meter cubed volume of the internal compartment to contain the plasma. The radius of the superconductors must be 6.93 meters with a thickness of the inner wall of the chamber made of tungsten at 0.5 meter. The total volume of the device being 47.6 meters cubed including all parts in a torus shape with a 1 meter cubed storage for the plasma of hydrogen and carbon 12. The superconductors will have to be cooled with liquid nitrogen or liquid helium which will require flow of the coolant through the outer shell of the device made of superconductors using the same technology used on current deuterium/tritium fusion reactors to cool the device. Electricity will have to be applied to the superconductors to keep the magnetism present of the superconductors.

Sixth, The plasma turbulence at a compression of 30 PetaNewtons the turbulence should be minimal the plasma being more of a circular “beam” of hydrogen and carbon 12. There will still be minor differences in density of the plasma to some degree however being hyper-compressed by the magnetic field should make for little problems with the reaction much like the reaction that happens in stars with the Carbon Nitrogen Oxygen Cycle (CNO). The goal of this is to obtain conditions similar to a star in the reaction chamber as with all fusion reactors which should be possible at 30 PetaNewtons of compression by the outer chamber of superconducting wire.

### HOW TO USE

The “Carbon Fusion Reactor” uses hydrogen and carbon 12 at a 4:1 ratio this mixture will need to be maintained a fed into the device. The sodium 22 must be fed into the device as well to maintain a temperature of 100 million kelvin. If these conditions are met then a total of 42.3 Terajoules of energy will be liberated from the reaction per chamber load of reactants which can be removed from the reactor in the form of plasma to heat water. The water then turns to steam moving a turbine generating electricity for consumption by the people the reactor is being used by.

1. Any usage of a Nuclear Fusion Reactor using the Carbon Nitrogen Oxygen cycle (CNO) for transforming non-isotope hydrogen into energy and various particles such as positrons at 16 million kelvins or higher temperature.

2. Any usage of Sodium 22 isotopes that generate positrons to heat the plasma of the Nuclear Fusion Reactor to generate a self-sustaining reaction at 16 million kelvins or higher of the Carbon Nitrogen Oxygen Cycle (CNO).

3. The method of claim 1 the usage of any Carbon Nitrogen Oxygen Cycle (CNO) to generate energy making a “Carbon Fusion Reactor”.
